(19) United States
(12) Patent Application Publication
(10) Pub. No.: US 2015/0214787 A1
(43) Pub. Date: Jul. 30, 2015

(54) AC MOTOR DRIVE POWERED CONCURRENTLY BY AC GRID AND DC SOLAR ARRAY

(71) Applicant: Nextronex, Inc., Holland, OH (US)

(72) Inventors: Peter Gerhardinger, Maumee, OH (US); Richard Ashton, Perrysburg, OH (US); Dillon Ashton, Pemberville, OH (US)

(21) Appl. No.: 14/601,357

(22) Filed: Jan. 21, 2015

Related U.S. Application Data
(60) Provisional application No. 61/931,857, filed on Jan. 27, 2014.
(60) Provisional application No. 62/077,943, filed on Nov. 11, 2014.

(51) Int. Cl. H02J 13/00; H02J 1/00; H02J 3/01

(52) U.S. Cl. CPC H02J 13/0096; H02J 3/01; H02J 1/00

(57) ABSTRACT

A system and method uses solar generated DC electricity to power an AC component in parallel with an AC grid via a variable frequency motor drive (VFD). During operation of the DC solar array a DC grid voltage is adjusted via a signal to a first rectifier to maintain the DC grid voltage below a DC array voltage such that power for operation of the AC component is preferentially sourced from the DC solar array. The system and method maintain the use of renewable energy to augment or largely replace expensive grid connected energy.

### CROSS-REFERENCE TO RELATED APPLICATIONS

The present application claims priority to U.S. Provisional Application Ser. No. 61/931,857 filed Jan. 27, 2014, and to U.S. Provisional Application Ser. No. 62/077,943 filed Nov. 11, 2014. The foregoing Applications are incorporated by reference herein in their entirety.

### FIELD

The present invention relates generally to AC distribution systems, and, more specifically, to an AC distribution system connected to an AC grid and a DC solar array.

### BACKGROUND

A photovoltaic (PV) array is a linked collection of solar panels (modules), which are made of multiple interconnected solar cells that convert light energy into direct electrical current (DC), via the photovoltaic effect. However, most commercial and residential applications of electricity require alternating electrical current (AC) that typically is provided by power generating facilities. Upon generating the alternating current, the power generating facilities transmit the generated alternating current into an electrical grid system.

In order for most commercial and residential users to utilize the electricity generated by the solar panels, the direct current from the solar panels is typically transformed into alternating current. This is achieved by way of an electrical device known as an inverter, the output of which can be subsequently tied to for distribution onto the electrical grid system.

In areas of the world where the cost of grid connected electricity is very high due to, for example, the use of imported diesel fuel driven generators, or where the electricity provided by the grid is not reliable, it is common practice to use photovoltaic solar arrays to augment or largely replace the use of grid electricity when the sun is shining. In the traditional arrangement identified above, the solar array feeds synchronous inverters to initially feed on-site loads, and then feeds excess AC power into the grid. This requires permission and permitting from the local electrical authority, which may be difficult, time consuming, and expensive to obtain, or it may not be obtainable for various reasons. Also, commercial and residential users, when unable to rely on the grid electricity, use their own expensive to fuel diesel generators to offset or augment grid power.

It would be desirable to develop a system and method to use solar generated DC electricity to power an AC motor, or a series of motors or loads in parallel with the AC grid.

### SUMMARY

Concordant and congruous with the present invention, a system and method using solar generated DC electricity to power an AC motor in parallel with the AC grid via a Variable Frequency Motor Drive (VFD) has surprisingly been discovered.

According to several aspects, a system for powering an AC component concurrently by an AC grid and a DC solar array includes an AC grid connected to a DC bus through a first rectifier, the first rectifier defining a controlled rectifier acting to rectify an AC grid voltage to generate a DC grid voltage (Vgrid). A solar array is connected to the DC bus in parallel with the AC grid, the solar array creating a DC array voltage. A first isolation transformer is positioned in the DC bus between the AC grid and the first rectifier. An AC component is connected through a variable frequency drive (VFD) to the DC bus. During operation of the solar array whenever the solar DC array voltage exceeds the DC grid voltage Vgrid, power for operation of the AC component is preferentially sourced from the solar array.

According to other aspects, a method for powering at least one AC motor concurrently by an AC grid and a DC solar array includes: connecting the AC grid to a DC bus through a controlled rectifier positioned in the DC bus; connecting a solar array to the DC bus in parallel with the AC grid, the solar array generating a DC array voltage; rectifying an AC grid voltage to generate a DC grid voltage (Vgrid); controlling a variable frequency drive (VFD) connected to the DC bus to operate an AC motor connected to the VFD; and during operation of the solar array continuously adjusting the DC grid voltage Vgrid via a signal to the controlled rectifier to maintain the DC grid voltage below the solar DC array voltage such that power for operation of the AC motor is preferentially sourced from the solar array.

According to further aspects, a method for powering at least one AC motor concurrently by an AC grid and a DC solar array, includes: connecting the AC grid to a DC bus via a rectifier that feeds the DC bus; isolating the AC grid from the DC bus using an isolation transformer positioned in the DC bus; connecting a solar array to the DC bus in parallel with the AC grid, the solar array generating a DC array voltage; rectifying an AC grid voltage to generate a DC grid voltage (Vgrid); and routing current from the DC bus to a variable frequency drive (VFD) connected to the DC bus to operate an AC motor connected to the VFD.

The systems and methods of the present disclosure provide several advantages including using “renewable” energy such as solar energy to augment or largely replace expensive grid connected energy, while eliminating the need for an interconnect agreement or contract to connect into the AC grid, as well as improved frequency regulation of the AC. This disclosure applies in part to operation of AC motors, which may be used, but are not limited to such applications as reverse osmosis water purification, water distribution, air conditioning and air handling, mining, and industrial applications.

### DRAWINGS

The above, as well as other advantages of the present invention, will become readily apparent to those skilled in the art from the following detailed description of embodiments of the invention when considered in the light of the accompanying drawings in which:

FIG. 1 is a schematic representation of a first system for an AC motor drive powered concurrently by an AC grid and a DC solar array of the present invention;

FIG. 2A is a schematic representation of a system modified from the system of FIG. 1;

FIG. 2B is a graphical representation of AC motor power thresholds both during a clear diurnal day and a partly cloudy diurnal day;

FIG. 3 is a schematic representation of a system modified from the systems of FIGS. 1 and 2A;

FIG. 4 is a schematic representation of a system modified from the systems of FIGS. 1, 2A, and 3;

FIG. 5 is a graphical representation of the difference in operating voltages for a solar array between summer and winter periods;

FIG. 6 is a schematic representation of a system modified for simultaneous operation of multiple AC components;

FIG. 7 is a schematic representation of a system modified for operation of two parallel connected AC components using a single VFD;

FIG. 8 is a schematic and graphical representation of a system modified for simultaneous operation of multiple components; and

FIG. 9 is a graphical representation of the difference in bus voltages of an exemplary solar array compared to exemplary rectified grid voltage set points.

### DETAILED DESCRIPTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

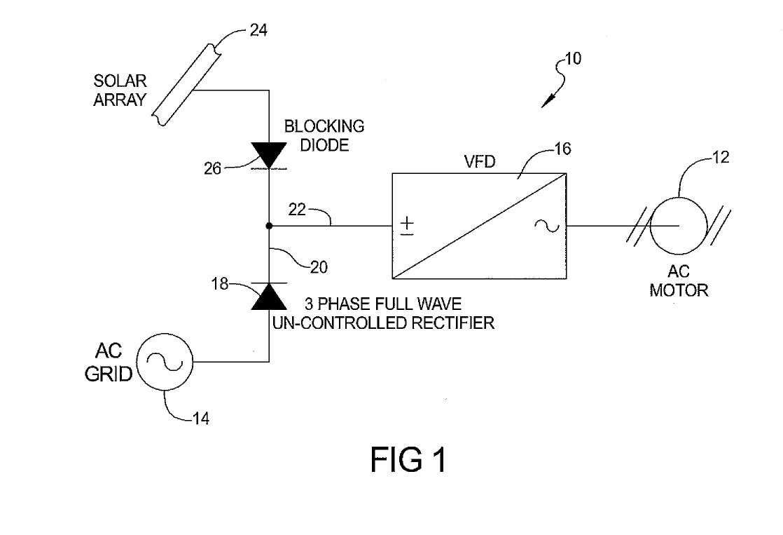

Referring to FIG. 1, in a first system 10 and method of operation for an AC component powered concurrently by an AC grid and a DC solar array, an AC motor 12 is connected to an AC grid 14. Solar generated DC power is connected in parallel with the AC grid 14 to power the AC motor 12 via a variable frequency drive (VFD) 16. AC voltage from the AC grid 14 is first rectified using an un-controlled 3-phase full wave rectifier 18 positioned in a common direct current conduction DC bus 20 and supplied via a bus 22 to the VFD 16. In addition to the source of DC voltage provided from the rectified AC grid 14, the DC voltage generated by a solar array 24 is also connected to the common DC bus 20 in parallel with the AC grid 14. A second rectifier defining a blocking diode 26 is provided in the DC bus 20 between the VFD 16 and the solar array 24. The rectifier 18 prevents DC back-feed to the AC grid 14.

The 3-phase full wave rectifier 18 sets a rectified bus DC voltage. During operation of the solar array 24, whenever a solar DC voltage (VDC array) exceeds the rectified grid DC voltage (Vgrid), power for operation of the AC motor 12 is preferentially sourced from the solar array 24.

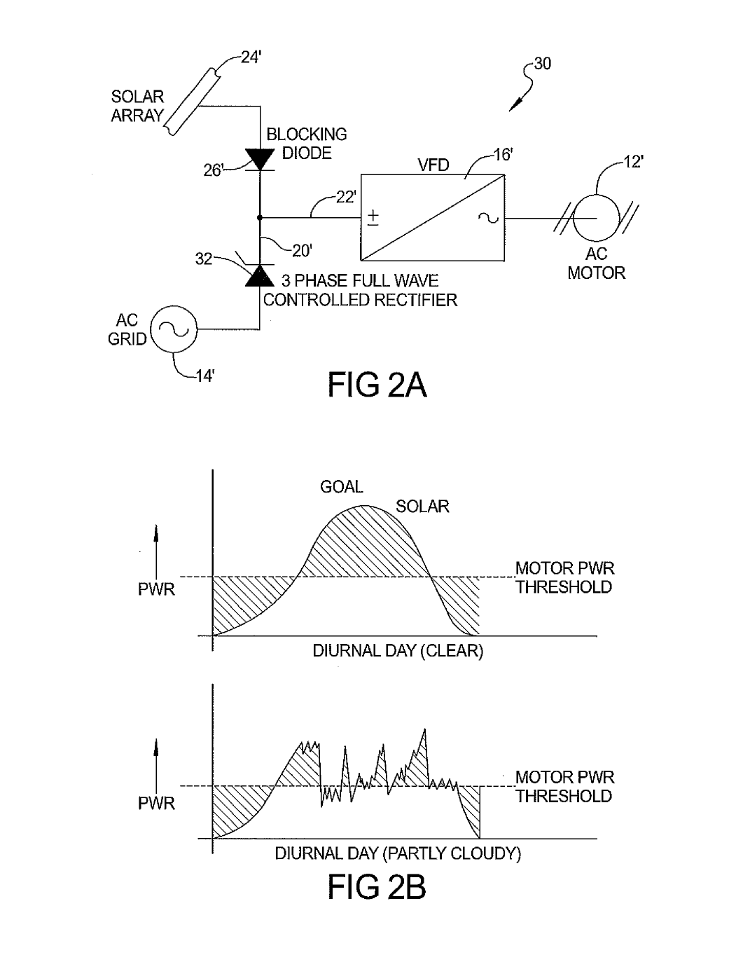

Referring to FIG. 2A and again to FIG. 1, a second system 30 includes multiple components similar to the first system 10, with common components identified by a prime symbol. In second system 30, AC voltage from the AC grid 14′ is rectified using a controlled 3-phase full wave rectifier 32 positioned in the DC bus 20′ and is supplied via the DC bus 22′ to the VFD 16′. The controlled 3-phase full wave rectifier 32 can set a rectified grid DC voltage. During operation of the solar array 24′, whenever the solar DC voltage (VDC array) exceeds the rectified grid DC voltage (Vgrid), power for operation of the AC motor 12′ is preferentially sourced from the solar array 24′, and the controlled rectifier reduces the rectified DC voltage to better utilize solar contribution from the solar array 24′ of the second system 30.

Referring to FIG. 2B and again to FIGS. 1 and 2A, an AC motor power varies when supplied by a solar array when conditions are clear or cloudy. During clear solar array operating conditions motor power threshold is steady and builds evenly. During cloudy or partly cloudy conditions, motor power threshold is broken, and the system is therefore supplemented with battery power and/or with DC voltage rectified from the AC grid to even out system voltage variations.

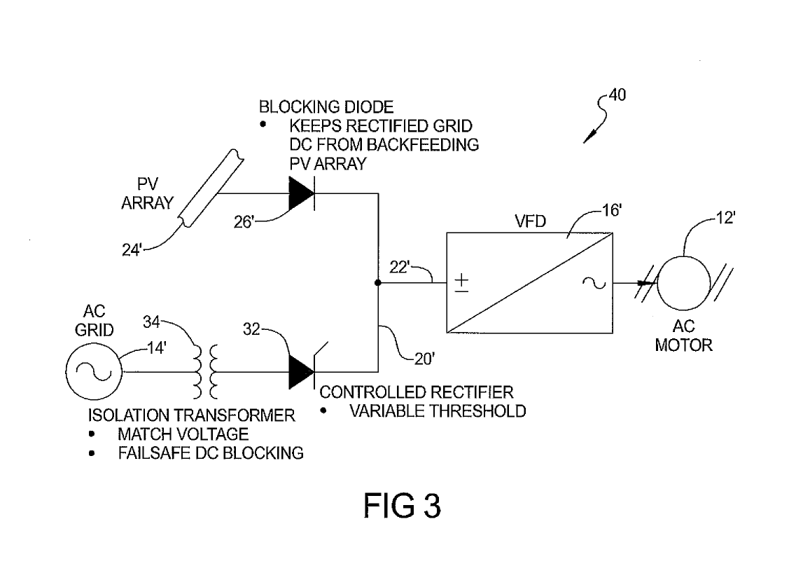

Referring to FIG. 3 and again to FIGS. 1-2A, a third system 40 includes multiple components similar to the first system 10 and the second system 30, with common components identified by a prime symbol. In third system 40, AC voltage from the AC grid 14′ is rectified using the controlled 3-phase full wave rectifier 32 in the DC bus 20′ and supplied via the DC bus 22′ to the VFD 16′. Third system 40 further provides additional features of fail-safe isolation between the DC current from the solar array 24′ and the AC grid 14′, and allows for (evens out) voltage variation in the DC voltage generated by the solar array 24′. To provide these features, third system 40 includes a first isolation transformer 34 in the DC bus 20′ between the AC grid 14′ and the controlled 3-phase full wave rectifier 32. First isolation transformer 34 in front of the controlled 3-phase full wave rectifier 32 prevents DC back-feed to the AC grid 14′ even in the event of a short in the controlled 3-phase full wave rectifier 32 thereby obviating the requirement to obtain permission and permitting from the local electrical authority for operation of system 40. First isolation transformer 34 parameters can be selected such that a voltage output is matched or “tuned” to the voltage requirement of a particular AC motor 12′.

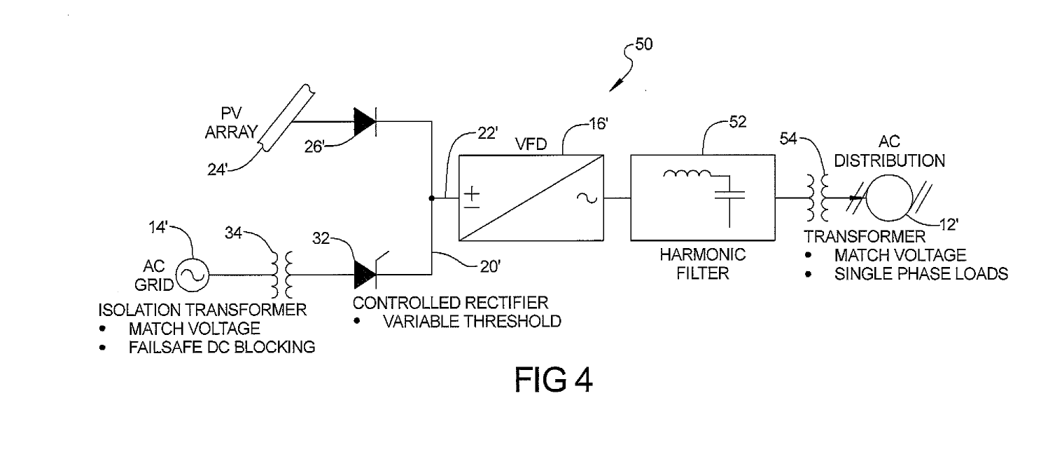

Referring to FIG. 4 and again to FIGS. 1-3, a fourth system 50 includes multiple components similar to the first system 10, the second system 30, and the third system 40, with common components identified by a prime symbol. In fourth system 50, AC voltage from the AC grid 14′ is rectified using the controlled 3-phase full wave rectifier 32 in the DC bus 20′ and supplied via the DC bus 22′. Fourth system 50 further includes a harmonic filter 52 after the VFD 16′, and a second isolation transformer 54 between the harmonic filter 52 and the AC motor 12′. Harmonic filter 52 minimizes specific harmonics in the frequency produced by the VFD 16′, and therefore reduces current fluctuations to the AC motor 12′. This increases motor life and reduces motor maintenance. The second isolation transformer 54, similar to first isolation transformer 34, is used to match or “tune” the voltage from the VFD 16′ and further provides for control of single phase loads of the AC motor 12′.

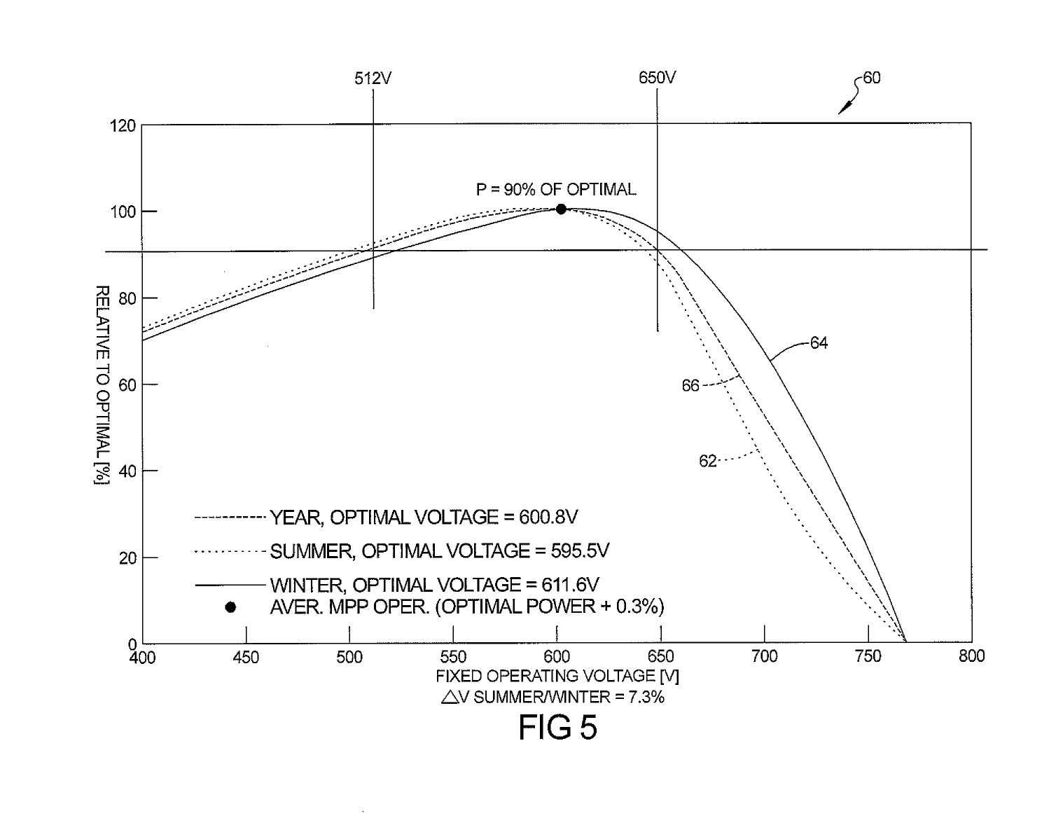

Referring to FIG. 5, a graph 60 identifies a fixed operating voltage in relation to a percentage of optimal power “P” for operation for an exemplary solar array operating in the Caribbean region. The difference between a summer optimal voltage curve 62 and a winter optimal voltage curve 64 demonstrates that the voltage output from the solar array does not substantially vary based on season, and therefore does not vary substantially by temperature of the array. At P=90% of optimal, voltage ranges between approximately 512V to 650V. At P=90% the seasonal summer/winter voltage difference is approximately 7.3%. This voltage differential is small enough such that year round operation of the system using the DC voltage of the solar array can be relied on, particularly in reference to operation of the third system 40 and the fourth system 50. For applications where daytime equipment operation exceeds the power requirements of nighttime operated equipment, the solar array portions of the systems of the present disclosure can be relied on to provide year round daytime power to the common DC bus.

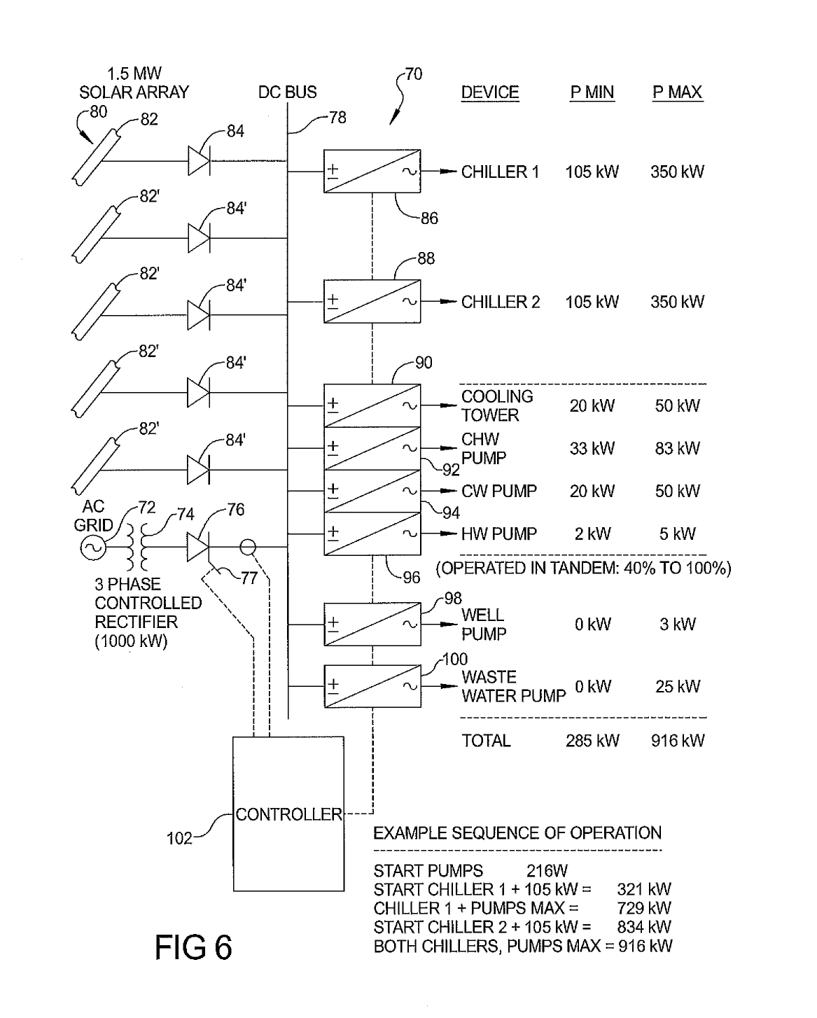

Referring to FIG. 6, an exemplary power system 70 using components identified for systems 10, 30, 40, and 50 herein is presented. System 70 is connected to an AC grid 72 via an isolation transformer 74 (performing the isolation function similar to first isolation transformer 34 discussed in reference to FIG. 3) in a bus between the AC grid 72 and a controlled 3-phase full wave rectifier 76. Controlled full wave rectifier 76 is used to set a rectified bus DC voltage in a common DC bus 78. A solar array 80 according to several aspects generates 1.5 MW via multiple array panels 82, 82′. DC output from each of the array panels 82, 82′ is individually connected by a blocking diode 84, 84′ to the DC bus 78 in parallel with the rectified DC power from the AC grid 72. Multiple components are powered from the DC bus 78, each via an individual VFD sized for the individual power requirements of the individual components. For example, a high power chiller 1 having a minimum power rating of 105 kW and a maximum power rating of 350 kW is connected to the DC bus 78 using a VFD 86. Similarly, an equally sized chiller 2 is connected to the DC bus 78 using a VFD 88. System 70 can further include a panel or substation (not shown) positioned between the inverters and the loads.

Multiple components having a lower power rating than chiller 1 or chiller 2 are also connected to the DC bus 78. These include a cooling tower having a minimum power rating of 20 kW and a maximum power rating of 50 kW connected to the DC bus 78 using a VFD 90, a chilled water (CHW) pump having a minimum power rating of 33 kW and a maximum power rating of 83 kW connected to the DC bus 78 using a VFD 92, a cooling water (CW) pump having a minimum power rating of 20 kW and a maximum power rating of 50 kW connected to the DC bus 78 using a VFD 94, and a hot water (HW) pump having a minimum power rating of 2 kW and a maximum power rating of 5 kW connected to the DC bus 78 using a VFD 96.

System 70 can also be used to operate low power consumption equipment which may frequently be non-operational for extended periods, such as a well pump having a minimum power rating of 0 kW and a maximum power rating of 3 kW connected to the DC bus 78 using a VFD 98, and a waste water pump having a minimum power rating of 0 kW and a maximum power rating of 25 kW connected to the DC bus 78 using a VFD 100.

In order to optimize operation of each of the components of system 70, as well as any of the systems of the present disclosure, a controller 102 such as a programmable logic controller is connected to and directs operational parameters such as voltage, frequency, and pump operational speed as necessary for the components connected to each of the VFDs 86, 88, 90, 92, 94, 96, 98, and 100. Controller 102 is further connected to a gate 77 of the controlled 3-phase full wave rectifier 76 and monitors at least a current of DC bus 78. During daytime operation of the solar array 80, a timer, a light sensor, or a similar device (not shown) can further be connected to the controller 102 to identify when the solar array 80 has available solar energy, however, these components are not required for system operation because the system is substantially self-regulating after the DC grid voltage Vgrid is selected and set below the DC array voltage. The controller 102 is in communication with the VFDs and the first rectifier (gate of controlled 3-phase full wave rectifier 76). The DC grid voltage Vgrid is set below the DC array voltage by a signal from the controller 102 to gate 77 of the first rectifier, and can be modified by the controller 102.

When a solar DC voltage (VDC array) of the solar array 80 exceeds the rectified grid DC voltage (Vgrid) of AC grid 72, power for operation of the desired components connected to each of the VFDs 86, 88, 90, 92, 94, 96, 98, and 100 is preferentially sourced from the solar array 80. The rectified grid DC voltage (Vgrid) of AC grid 72 continues to be available if for example a temporary drop in the voltage and/or current from the solar array 80 occurs such as during overcast conditions, or system power requirements temporarily exceed the current available from the solar array 80. Although as discussed herein the DC voltage of the solar array 80 does not vary significantly, because the DC current available from the solar array 80 is directly affected by incident solar energy, the current available at any given time from the solar array 80 can also be monitored such that equipment can be sequentially brought on line to minimize drawing power from the AC grid 72.

In an exemplary sequence of startup operation, in a first step controller 102 initiates operation of various ones of the pumps, which according to an exemplary operation draws 216 W. In a second step controller 102 starts chiller 1, adding 105 kW to the power drawn by the operating pumps. In a third step controller 102 starts chiller 2, adding an additional 105 kW to the power drawn by chiller 1 plus the operating pumps. According to further aspects, system 70 can also operate in conjunction with additional non-grid generators (not shown) such as but not limited to micro-turbines and/or diesel generators.

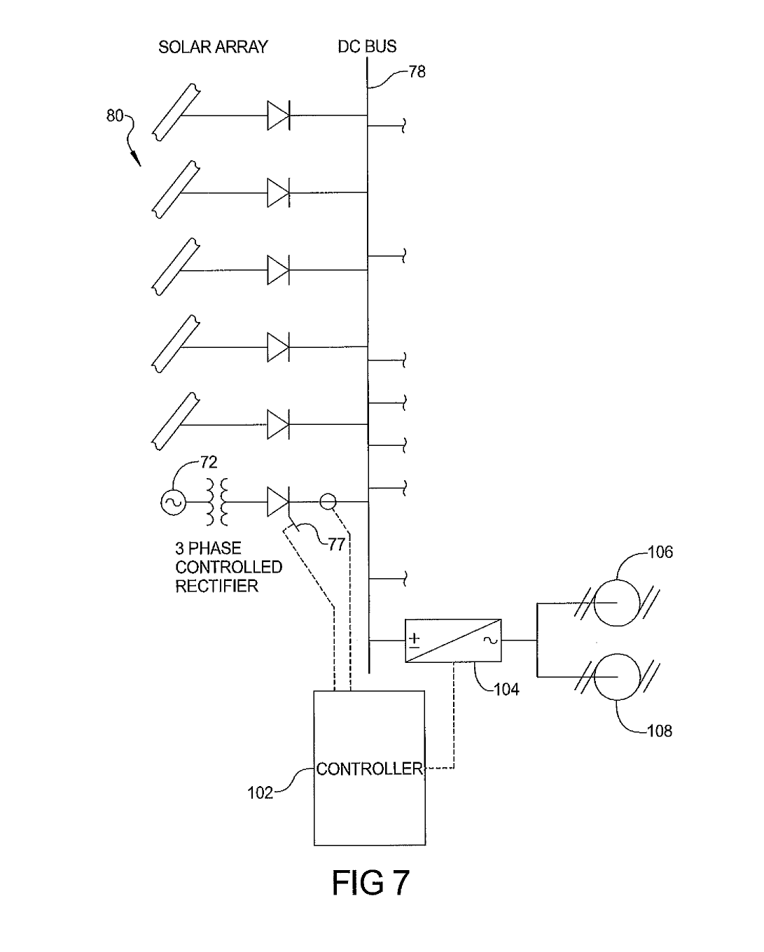

Referring to FIG. 7, system 70 is modified to present an additional benefit of the systems and methods of the present disclosure which applies to control of industrial machines, for example injection molding machines which have a very cyclical power consumption. Punch presses and other large machines also have cyclical power consumption. When only a single machine is driven from the controller 102, a substantial portion of the solar fraction or power available from the solar array 80 may be lost when the machine is “idling” when there is no storage or grid feed.

Because most industrial installations have more than one machine, often with identical parts being run, these machines often have identical cycles, with identical or nearly identical operational frequencies that can be operated by a single VFD. In order to capture more of the solar fraction of the solar array 80, two or more machines or motors, presented for example as a first AC motor 106 and a second AC motor 108, are connected to a single VFD 104, which is connected to DC bus 78, with an interface to the controller 102. According to one operating aspect, a signal is provided, either to the first AC motor 106 controller or to the second AC motor 108 controller directly, or via a visual signal to an operator, showing when a given one of the first AC motor 106 (and its operated machine) or the second AC motor 108 (and its operated machine) is ready for its operating cycle. This could be a simple red light/green light arrangement, or an actual start signal provided directly to the motor or machine controller. Controller 102 continuously monitors the rectified grid DC voltage (Vgrid) of AC grid 72 and the solar DC voltage (VDC array) of the solar array 80 and provides operational control of one or both of the first AC motor 106 and the second AC motor 108 based on a preprogrammed operational sequence, or the present demand.

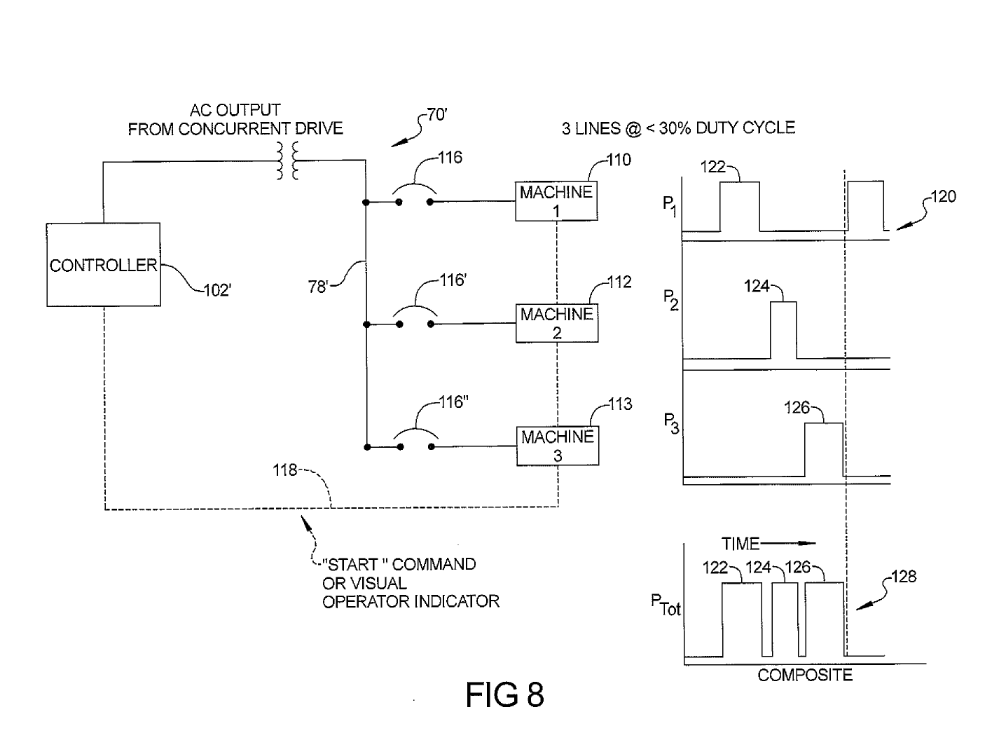

Referring to FIG. 8, a system 70′ is modified to provide for operation of multiple loads at the same time. Where the loads are cyclical, such as injection molding machines or punch presses, the solar utilization could be fairly low, because there is no storage or alternative place to use the solar energy when the machines are “idling”, therefore during these conditions the solar energy is not being harvested. However, with multiple machines operating at once, which is common in industrial applications, two or more machines can be sequentially powered depending on their duty cycle, and machine operation can be staggered, for example using a transfer relay, or a visual (operator) indicator. In modified system 70′, a first machine 110, a second machine 112, and a third machine 114 are each connected to the bus 78′. A load rated disconnect 116 is positioned between first machine 110 and the bus 78′. Similar disconnects 116′ are provided between the bus 78′ and each of the second machine 112 and the third machine 114. Each of the first, second, and third machines 110, 112, 114 are connected to the controller 102′ via a communication line 118. Operation of any or all of the machines is initiated using a signal such as a red light/green light arrangement, or an actual start signal provided directly to the motor or via the controller 102′.

As an exemplary operation:

1. If it is confirmed that the duty cycles of two machines are between approximately 36% and 50%, the two machines such as the first machine 110 and the second machine 112 may be connected and sequentially operated from the same VFD.

2. If it is confirmed that the duty cycles of three machines are between approximately 26% and 33%, the three machines such as the first, second, and third machines 110, 112, 114 may be connected and sequentially operated from the same VFD.

3. If it is confirmed that the duty cycles are between 21% and 25%, an additional fourth machine (not shown) may be connected and sequentially operated in addition to the first, second, and third machines 110, 112, 114 from the same VFD.

As further presented in FIG. 8, a graph 120 of the operating power of each of the sequentially operated machines is presented over time. As noted above, it is presumed the duty cycle is between approximately 26% and 33%, therefore all three of the first, second, and third machines 110, 112, 114 can be operated. A power curve 122 for the first machine 110, a power curve 124 for the second machine 112, and a power curve 126 for the third machine 114 are staggered over time as presented in a composite power graph 128 which demonstrates staggered operation of multiple machines using solar energy and VFDs of the present disclosure to provide a steady power flow.

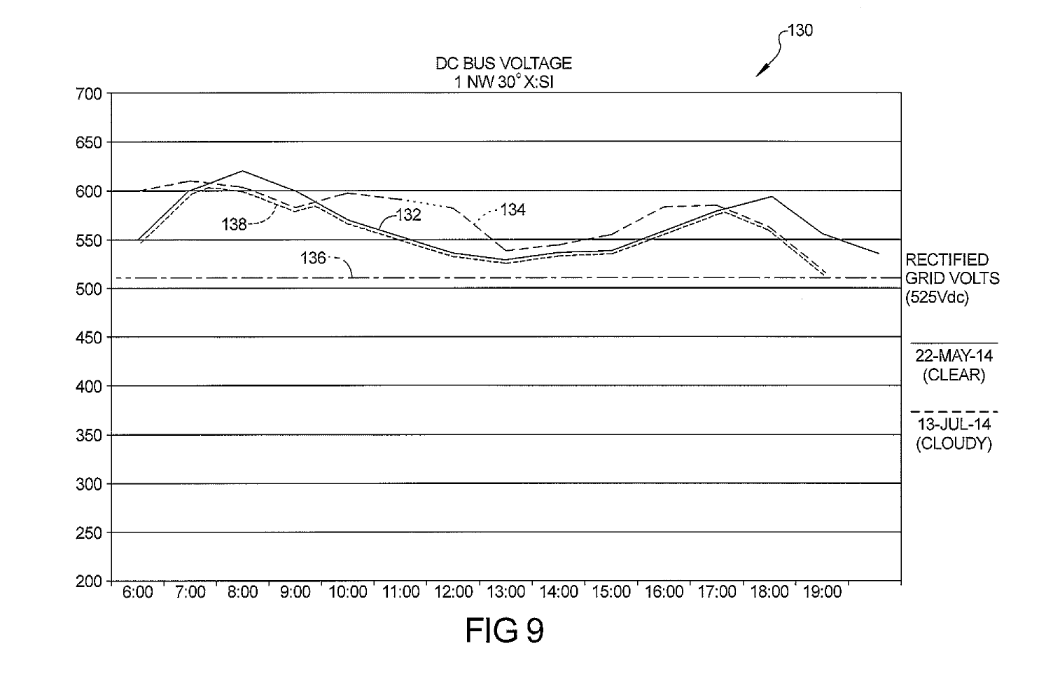

Referring to FIG. 9, a graph 130 presents DC bus voltage for two different days, a first bus voltage curve 132 for May 22, 2014 (clear weather conditions), and a second bus voltage curve 134 for Jun. 13, 2014 (cloudy weather conditions), for an exemplary 1 MW solar array using weather data for Toledo, Ohio with data from a typical meteorological year (TMY). Graph 130 demonstrates that over different weather condition days and therefore different power generation conditions, the minimum DC voltage of the bus was approximately 530 VDC and the maximum DC voltage of the bus was approximately 625 VDC. By setting a rectified AC grid voltage of 525 VDC as shown by voltage line 136, the exemplary solar array would drive all power requirements above 525 VDC. To provide closer control of the system, for example to more closely adapt when solar energy wanes during cloudy periods even during the same day, the systems of the present disclosure can also be operated to provide a rectified DC voltage from the AC grid voltage, depicted as AC grid voltage line 138. The rectified DC voltage provided via AC grid voltage line 138 can be set to remain a minimum voltage value (for example 10 VDC) below the actual tracked minimum DC voltage of the solar array, and either averaged for a given time period, or continuously modified per day. The voltage of the solar array as the DC bus voltage for systems of the present disclosure can therefore be variable, and the AC grid voltage as rectified DC voltage can be varied to closely match the solar array driven DC bus voltage.

The present invention utilizes controlled variable frequency drives, such as VFD 16, wherein “normal” three phase input is maintained, and an additional DC input is provided for a direct connection to a solar array 24, 80, wired such that the operating voltage of the solar array 24, 80 will not exceed the DC bus voltage of the VFD 16 or of any of the of the VFDs 86, 88, 90, 92, 94, 96, 98, and 100 under sunny conditions. Whenever energy is available from the solar array, the controller 102 sets the rectified AC voltage level just under the array voltage level, such that power preferentially flows from the solar array, and not from the AC grid. The AC grid power remains available to buffer cloud transients and to insure a reliable source of power whenever the photovoltaic output is insufficient to power the load, including at night. Depending on the size of the array, and the operational sequence of the various motors or load members, a higher percentage of the electrical power will be sourced from the solar array than from the AC grid. Because the systems and methods of the present disclosure do not define or use a solar inverter, there is no connection to feed power back to the AC grid. DC power cannot be impressed onto the AC grid because components such as first isolation transformer 34 protect against component failure in the DC power supply.

### Operational Test

According to one example of a method of the invention for one embodiment of the system of the invention, an internal DC bus of a VFD receives its energy from either the input from the rectified AC grid, or the solar DC input line depending on which voltage is higher. Testing of the method was performed using a solar simulator. The VFD of the system was fed via an isolated 380 V AC 3-phase feed. This was chosen to eliminate any interaction with the DC solar simulator, which was also fed from three phase AC, and to provide sufficient voltage range from the DC simulator output to exceed the internal VFD DC bus voltage.

1. Motor Powered by the VFD fed from the AC grid only:

Once the VFD parameters were properly set, the motor powered normally, and the speed was readily adjusted via a VFD keypad. To simulate a motor load a simple brake consisting of an 8 ft.×0.5 ft×1″ piece of white oak was pressed against the pulley. It proved possible to stall the motor with this load. With limited instrumentation the following was measured:

AC Voltage: 372V (nominal) each phase

No Load Current (AC) 1.5 A per phase

Full Load Current: 11.5 A per phase

(No Power Factor Correction): No load power draw: 1.5 A*372V*Sqr 3=965 VA;

Full load power draw: 11.5 A*372V*Sqr 3=7400 VA

2. Motor powered by VFD fed from AC grid and DC solar simulator

With the AC motor running under no load conditions, the DC simulator voltage was increased. The maximum recorded DC level was 680V, which is within the range of known solar arrays wired in 1000V strings. When the DC supply was brought up, the no-load current from the AC grid dropped from 1.5 A to 0.53 A. Based on the calculation above, this produces 341 VA. When the motor was loaded, the AC grid draw increased slightly to 0.6 A per phase. This corresponds to an AC draw of 386 VA.

3. Results

Under no-load conditions, the solar simulator provided 65% of the energy, with 35% corning from the AC grid. Under heavy load conditions, the solar simulator provided 95% of the energy, with 5% coming from the AC grid.

The systems and methods of the present disclosure maintain the advantage of using “renewable” solar array energy to augment or largely replace expensive grid connected energy, while eliminating the need for an interconnect agreement or contract for the grid tie-in. The systems and methods of the present disclosure are applicable at least to AC motors, which may be used in such applications as Reverse Osmosis Water Purification, Water Distribution, Air Conditioning and Air Handling, Mining, and Industrial Applications.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A system for powering an AC component concurrently by an AC grid and a DC solar array, comprising:
an AC grid connected to a DC bus through a first rectifier positioned in the DC bus, the first rectifier including a controlled rectifier acting to rectify an AC grid voltage from the AC grid to generate a DC grid voltage to the DC bus;
a DC solar array connected to the DC bus in parallel with the AC grid, the solar array creating a DC array voltage;
a first isolation transformer positioned between the AC grid and the first rectifier; and
an AC component connected through a variable frequency drive (VFD) to the DC bus, wherein during operation of the solar array whenever the solar DC array voltage exceeds the DC grid voltage, power for operation of the AC component is preferentially sourced from the solar array.

2. The system for powering an AC component concurrently by an AC grid and a DC solar array of claim 1, further comprising a second rectifier positioned in the DC bus between the solar array and the first rectifier, the VFD connected to the DC bus between the first rectifier and the second rectifier.

3. The system for powering an AC component concurrently by an AC grid and a DC solar array of claim 2, wherein the first rectifier is an un-controlled 3-phase full wave rectifier.

4. The system for powering an AC component concurrently by an AC grid and a DC solar array of claim 2, wherein the first rectifier is a controlled 3-phase full wave rectifier having a variable threshold.

5. The system for powering an AC component concurrently by an AC grid and a DC solar array of claim 2, wherein the second rectifier is a blocking diode.

6. The system for powering an AC component concurrently by an AC grid and a DC solar array of claim 1, further comprising a harmonic filter positioned between the VFD and the AC component.

7. The system for powering an AC component concurrently by an AC grid and a DC solar array of claim 6, further comprising a second isolation transformer positioned between the harmonic filter and the AC component.

8. The system for powering an AC component concurrently by an AC grid and a DC solar array of claim 2, further comprising:
a second VFD connected to the DC bus between the first rectifier and the second rectifier; and
a second AC component connected to the second VFD, with power for operation of the second AC component also being preferentially sourced from the solar array.

9. The system for powering an AC component concurrently by an AC grid and a DC solar array of claim 8, further comprising a controller in communication with each of the first VFD and the second VFD, wherein the DC grid voltage is set below the DC array voltage by a signal to a gate of the first rectifier from the controller.

10. The system for powering an AC component concurrently by an AC grid and a DC solar array of claim 1, further comprising a controller in communication with the VFD and the first rectifier, wherein the DC grid voltage is set below the DC array voltage by a signal from the controller to a gate of the first rectifier.

11. A method for powering at least one AC component concurrently by an AC grid and a DC solar array, comprising:
connecting an AC grid to a DC bus through a controlled first rectifier positioned in the DC bus;
connecting a solar array to the DC bus in parallel with the AC grid, the solar array generating a DC array voltage;
rectifying an AC grid voltage from the AC grid to generate a DC grid voltage;
controlling a first variable frequency drive (VFD) connected to the DC bus to operate a first AC component connected to the first VFD; and
during operation of the solar array continuously adjusting the DC grid voltage via a signal to the controlled first rectifier to maintain the DC grid voltage below the DC array voltage such that power for operation of the AC component is preferentially sourced from the solar array.

12. The method of claim 11, further comprising isolating the AC grid from the DC bus using a first isolation transformer positioned ahead of the DC bus and between the AC grid and the first rectifier.

13. The method of claim 11, further comprising connecting a second VFD to the DC bus to operate a second AC component connected to the second VFD.

14. The method of claim 11, further comprising connecting a second AC component to the first VFD and selectively controlling operation of one of the first or the second AC components using the first VFD.

15. The method of claim 11, further comprising identifying a lowest voltage of the DC array voltage and performing the adjusting the DC grid voltage step by keeping the DC grid voltage below the DC array voltage by a predetermined voltage.

16. A method for powering at least one AC component concurrently by an AC grid and a DC solar array, comprising:
connecting the AC grid to a DC bus through a first rectifier positioned in the DC bus;
isolating the AC grid from the DC bus using a first isolation transformer positioned between the AC grid and the first rectifier;
connecting the DC solar array to the DC bus in parallel with the AC grid, the DC solar array generating a DC array voltage;
rectifying an AC grid voltage generated by the AC grid to generate a DC grid voltage; and
routing current from the DC bus to a first variable frequency drive (VFD) connected to the DC bus to operate a first AC component connected to the first VFD.

17. The method of claim 16, further comprising during operation of the DC solar array adjusting the DC grid voltage via a signal to the first rectifier to maintain the DC grid voltage below the DC array voltage such that power for operation of the first AC component is preferentially sourced from the DC solar array.

18. The method of claim 16, further comprising selecting the first rectifier as a controlled rectifier having a gate receiving the signal.

19. The method of claim 18, further comprising monitoring at least the DC grid voltage using a controller in communication with the gate of the first rectifier and with the first VFD.

20. The method of claim 18, further comprising:
connecting a second VFD to the DC bus; and
controlling operation of the second VFD using the controller to power a second AC component connected to the second VFD.

21. The method of claim 16, further comprising:
connecting a second AC component to the first VFD;
confirming the duty cycle of each of the first AC component and the second AC component are in a range between approximately 36% and 50%; and
sequentially operating both the first AC component and the second AC component using the first VFD.
